(19) United States
(12) Patent Application Publication
(10) Pub. No.: US 2005/0207003 A1
(43) Pub. Date: Sep. 22, 2005

(54) Microscope

(75) Inventor: Shohei Kobayashi, Hino-shi (JP)

Correspondence Address: Scully, Scott, Murphy & Presser, 400 Garden City Plaza, Garden City, NY, 11530-3319, US

(73) Assignee: Olympus Corporation, Tokyo (JP)

(21) Appl. No.: 11/081,241

(22) Filed: Mar. 16, 2005

(30) Foreign Application Priority Data
Mar. 19, 2004 (JP) 2004-081540

(51) Int. Cl. G02B 21/00

(52) U.S. Cl. 359/368; D16/131

(57) ABSTRACT

A microscope includes an objective lens, an imaging lens, which constitutes an imaging optical system in cooperation with the objective lens, a wavefront modulator, which is located on an optical path between the objective lens and the imaging lens, and a light beam diameter controlling unit, which is located on the optical path between the wavefront modulator and the objective lens and changes the diameter of a light beam from the objective lens to a substantially constant diameter.

### CROSS-REFERENCE TO RELATED APPLICATIONS

This application is based upon and claims the benefit of priority from prior Japanese Patent Application No. 2004-081540, filed Mar. 19, 2004, the entire contents of which are incorporated herein by reference.

### BACKGROUND OF THE INVENTION

1. Field of the Invention

The present invention relates to a microscope having a wavefront modulator.

2. Description of the Related Art

For example, U.S. Pat. No. 6,771,417 B1 discloses a microscope having a wavefront modulator. In this microscope, a beam splitter is located between an objective lens forming an imaging system and a cylindrical lens for the formation of an intermediate image, and two reflection wavefront modulators are optically coupled to the imaging system through the beam splitter. The two wavefront modulators are arranged to face each other through the beam splitter. In addition, ¼ wavelength plates are respectively arranged between the wavefront modulators and the beam splitter.

A light beam from the objective lens is reflected by the beam splitter to enter one wavefront modulator. The light beam is reflected by the wavefront modulator and transmitted through the beam splitter to enter the other wavefront modulator. The light beam reflected by the wavefront modulator is then reflected by the beam splitter to enter the cylindrical lens.

In this microscope, the focal position of the objective lens can be moved along the optical axis by modulating the phase of the wavefront of a light beam by these wavefront modulators. In addition, aberrations due to specimens and sample environments can be corrected by properly deforming wavefronts using the wavefront modulators. Furthermore, aberration correction can be applied to the illumination system as well as the imaging system.

### BRIEF SUMMARY OF THE INVENTION

A microscope of the present invention comprises an objective lens, an imaging lens, which constitutes an imaging optical system in cooperation with the objective lens, a wavefront modulator, which is located on an optical path between the objective lens and the imaging lens, and a light beam diameter controlling unit, which is located on the optical path between the wavefront modulator and the objective lens and changes the diameter of a light beam from the objective lens to a diameter substantially equal to the optically effective diameter of the wavefront modulator.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the arrangement of a microscope according to the first embodiment of the present invention;

FIG. 2 shows the modulation amount of wavefront required to correct spherical aberration, i.e., the wavefront correction amount;

FIG. 3 shows an electrode pattern of a wavefront modulator that is constituted by a liquid crystal cell and suitable for the correction of spherical aberration;

FIG. 4 shows the arrangement of the microscope in which a light beam diameter controlling unit in FIG. 1 is replaced with a relay optical system;

FIG. 5 shows a preferred positional relationship among the objective lens, the relay optical system, and the wavefront modulator shown in FIG. 4;

FIG. 6 schematically shows the arrangement of a microscope according to the second embodiment of the present invention;

FIG. 7 schematically shows the arrangement of an electrostatic actuation type deformable mirror applicable to the wavefront modulator in FIG. 6;

FIG. 8 schematically shows a sectional shape of the thin-film mirror of the deformable mirror in FIG. 7 that is deformed to correct spherical aberration; and

FIG. 9 schematically shows the arrangement of a microscope according to the third embodiment of the present invention.

### DETAILED DESCRIPTION OF THE INVENTION

The embodiments of the present invention will be described below with reference to the accompanying drawing.

### First Embodiment

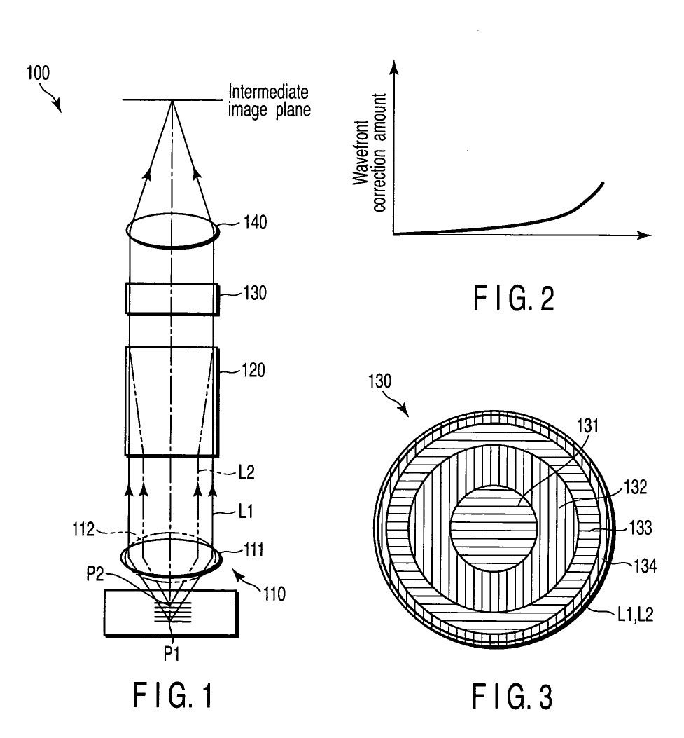

This embodiment is directed to a microscope having a transmission wavefront modulator. FIG. 1 schematically shows the arrangement of a microscope according to the first embodiment of the present invention.

As shown in FIG. 1, a microscope 100 of this embodiment comprises an objective lens 110, light beam diameter controlling unit 120, wavefront modulator 130, and imaging lens 140.

In this specification, the objective lens 110 indicates an objective lens located on the optical axis of the microscope 100, and is usually selected from objective lenses. In the following description, the objective lens 110 is either an objective lens 111 having a relatively low magnification or an objective lens 112 having a relatively high magnification. In the drawings, the imaging lens and objective lens are illustrated as single lenses, but, needless to say, they may comprise combination lenses, respectively.

The imaging lens 140 constitutes an imaging optical system in cooperation with the objective lens 110. The wavefront modulator 130 is located on an optical path between the objective lens 110 and the imaging lens 140. The light beam diameter controlling unit 120 is located on the optical path between the wavefront modulator 130 and the objective lens 110.

The wavefront modulator 130 can modulate the wavefront of a light beam having a diameter smaller than the optically effective diameter. The light beam diameter controlling unit 120 changes the diameter of a light beam from the objective lens 110 to a substantially constant diameter regardless of the magnification of the objective lens 110. More preferably, the light beam diameter controlling unit 120 changes the diameter of the light beam from the objective lens 110 to a diameter substantially equal to the optically effective diameter of the wavefront modulator 130. The light beam diameter controlling unit 120 preferably comprises a relay optical system including a movable lens that is movable along the optical axis.

Assume that a point P1 on an observation target is to be observed with the objective lens 111. Divergent light from the point P1 is converged into a light beam L1 by the objective lens 111. When the diameter of the light beam L1 is substantially equal to the optically effective diameter of the wavefront modulator 130, the light beam diameter controlling unit 120 is controlled so as not to change the diameter of the light beam L1. As a consequence, the light beam L1 passes through the light beam diameter controlling unit 120 without any change, and is wavefront-modulated by the wavefront modulator 130. The modulated light is focused at a point on an intermediate image plane by the imaging lens 140 to form an image. The image (intermediate image) formed by the imaging lens 140 is observed through, for example, an eyepiece (not shown).

If the point P1 is not present on the focal plane of the objective lens 111, spherical aberration due to defocusing has occurred with respect to the light beam L1 from the point P1. Correcting this spherical aberration by using the wavefront modulator 130 makes it possible to observe the point P1 substantially without any aberration even if the point P1 is not on the focal plane. In addition, adjusting the correction amount, i.e., the modulation amount, with the wavefront modulator 130 makes it possible to not only correct aberration but also observe an object (to be observed) at a position different from the focal plane without moving the object or objective lens 111 along the optical axis. That is, observation with moving the focal point can be performed.

Correction of spherical aberration due to defocusing by the wavefront modulator 130 will be described in detail below. Let r be the distance from the center of the light beam L1 within a plane perpendicular to the optical axis of the light beam L1. In order to correct spherical aberration, the wavefront modulator 130 modulates the wavefront of the light beam L1 into a shape proportional to the square (r²) of the distance from the center of the light beam L1. In order to correct spherical aberration up to high-order spherical aberration, the wavefront modulator 130 modulates the wavefront into a shape obtained by further adding a term proportional to r⁴, r⁶, . . . .

FIG. 2 shows the modulation amount of wavefront required for the correction of spherical aberration, i.e., the wavefront correction amount. Since the correction amount includes the term of r², r⁴, r⁶, . . . , with an increase in r, i.e., with an increase in distance from the center of the light beam L1, the wavefront correction amount greatly changes.

The wavefront modulator 130 may comprise, for example, a liquid crystal cell. FIG. 3 shows the electrode pattern of the wavefront modulator 130 that is constituted by the liquid crystal cell and is suitable for the correction of spherical aberration. As shown in FIG. 3, the wavefront modulator 130 constituted by the liquid crystal cell comprises ring-like electrodes 131, 132, 133, and 134, which are concentrically arranged. The ring-like electrodes 131, 132, 133, and 134 decrease in width with an increase in distance from the center.

The ring-like electrode 131 at the center actually has a circular shape, but herein, for the sake of descriptive convenience, this member will be referred to as the “ring-like electrode”. Assume that in this case, the width of the ring-like electrode 131 indicates the radius of the circle.

Spherical aberration is corrected by changing the refractive index of the liquid crystal cell for each of the rings corresponding to the ring-like electrodes 131, 132, 133, and 134 by applying different voltages to the ring-like electrodes 131, 132, 133, and 134, respectively. More specifically, higher voltages are applied to the ring-like electrodes 131, 132, 133, and 134 as they are located farther from the center. Since the ring-like electrodes 131, 132, 133, and 134 decrease in width and receive higher applied voltages with an increase in distance from the center, the change amount of refractive index of the liquid crystal cell changes more in portions located farther from the center. Consequently, the wavefront correction amount shown in FIG. 2 is obtained.

Referring to FIG. 1, assume that the objective lens 111 is then changed to the objective lens 112 to observe a point P2 on the observation target. Divergent light from the point P2 is converged into a light beam L2 by the objective lens 112. If the diameter of the light beam L2 is smaller than that of the light beam L1, the light beam diameter controlling unit 120 is controlled to change the diameter of the light beam L2 to make it substantially equal to that of the light beam L1. As a result, the diameter of the light beam L2 is increased by the light beam diameter controlling unit 120 to become substantially equal to the optically effective diameter of the wavefront modulator 130. The light beam L2 is then wavefront-modulated by the wavefront modulator 130 and focused at a point on the intermediate image plane by the imaging lens 140 to form an image. The image (intermediate image) formed by the imaging lens 140 is observed through, for example, the eyepiece (not shown).

In order to correct spherical aberration with respect to the light beam L2, wavefront modulation is performed so that the change in the wavefront correction amount with a change in the distance r from the center increases toward the outer periphery of the light beam as in the case of the light beam L1. Since the diameter of the light beam L2 is controlled by the light beam diameter controlling unit 120 to be substantially equal to that of the light beam L1, proper correction can be made by using the overall optically effective diameter of the wavefront modulator 130. For example, by the wavefront modulator 130 constituted by the liquid crystal cell shown in FIG. 3, as in the case of the correction of the light beam L1, the wavefront of the light beam L2 can be modulated, i.e., corrected, so that the change in the wavefront correction amount with a change in r increases toward the outer periphery of the light beam.

Controlling the diameter of a light beam that enters the wavefront modulator 130 by using the light beam diameter controlling unit 120 so as to match the optically effective diameter of the wavefront modulator 130 in this manner makes it possible to satisfactorily perform aberration correction by using the single wavefront modulator 130 with respect to light beams having different diameters corresponding to objective lenses with different magnifications. Note that aberration in this case is not limited to spherical aberration or high-order spherical aberration due to the movement of a focal point but includes coma and astigmatism. Although the wavefront modulator 130 constituted by the liquid crystal cell and suitable for the correction of spherical aberration is shown in FIG. 3, a wavefront modulator constituted by a liquid crystal cell and capable of handling coma and astigmatism in addition to spherical aberration is not shown in particular, but has an arrangement in which ring-like electrodes respectively comprise unisotropically-divided segments to correct rotationally asymmetric coma or astigmatism like the arrangement shown in FIG. 3.

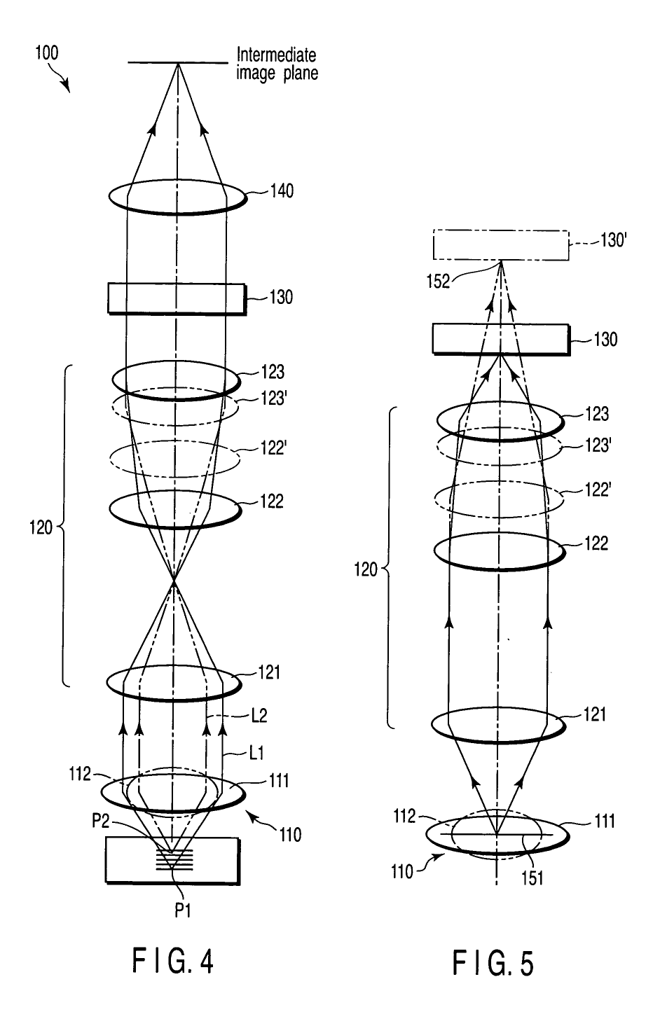

The relay optical system, which is a concrete arrangement of the light beam diameter controlling unit 120, will be described next. FIG. 4 shows the arrangement of the microscope in which the light beam diameter controlling unit in FIG. 1 is replaced with the relay optical system. The relay optical system 120 comprises three lenses 121, 122, and 123. The movable lenses 122 and 123 are movable along the optical axis. If the objective lens 110 is the objective lens 111, the movable lenses 122 and 123 are located at the positions indicated by the solid lines, and the relay optical system 120 guides the light beam L1 to the wavefront modulator 130 without changing its diameter. When the objective lens 110 is changed to the objective lens 112, the movable lenses 122 and 123 are moved to positions 122′ and 123′ indicated by the imaginary lines to guide the light beam L2 to the wavefront modulator 130 while changing its diameter to a diameter substantially equal to that of the light beam L1. Since the moving direction of the lenses is parallel to the optical axis, such a relay optical system can be easily constructed.

Wavefront modulation is preferably performed on the pupil plane of the objective lens 110. For this purpose, in practice, the wavefront modulator 130 is located at a position that is optically conjugate with the pupil of the objective lens 110. Assuming that the objective lens 110 is the objective lens 111, when the movable lenses 122 and 123 are at the positions indicated by the solid lines, the pupil plane of the objective lens 111 and the wavefront modulator 130 are optically conjugate to each other. At this time, the relay optical system 120 acts to arrange the pupil plane of the objective lens 111 and the wavefront modulator 130 in an optically conjugate relationship. That is, as shown in FIG. 5, a pupil 151 of the objective lens 111 is imaged on the wavefront modulator 130 by the relay optical system 120.

When the objective lens 110 is changed to the objective lens 112 and the movable lenses 122 and 123 are moved to the positions 122′ and 123′ indicated by the imaginary lines, since the magnification of the relay optical system 120 changes, the pupil plane of the objective lens 112 and the wavefront modulator 130 are out of the optically conjugate relationship. If the pupil of the objective lens 112 is positioned at the same position as that of the pupil of the objective lens 111 (the position of the pupil 151 in FIG. 5), the image of the pupil is formed at a position 152 shifted from the wavefront modulator 130. In order to compensate for this shift, the lenses 121, 122, and 123 are moved together to adjust the optical distance between the relay optical system 120 and the wavefront modulator 130 (i.e., the optical distance between the wavefront modulator 130 and the lens 123 of the relay optical system 120, which is located on the wavefront modulator 130 side). This makes it possible to arrange the pupil plane of the objective lens 112 and the wavefront modulator 130 in the optically conjugate relationship again. That is, the optical distance is adjusted to substantially set the wavefront modulator 130 at a position 130′ indicated by the imaginary line with respect to the relay optical system 120. For the sake of descriptive convenience, FIG. 5 shows that the wavefront modulator 130 moves relative to the relay optical system 120.

Information necessary for a change in the diameter of the light beam is preferably stored in, for example, a memory in the light beam diameter controlling unit 120 in advance. More specifically, necessary movable lens moving amounts are preferably obtained in advance by measuring the diameters of light beams exiting from all the objective lenses to be used, and stored in the memory in advance. When objective lenses are switched, necessary movable lens moving amounts corresponding to the selected objective lenses are preferably selected from the memory to move the movable lenses 122 and 123.

Likewise, necessary information associated with the adjustment of the optical distance between the light beam diameter controlling unit 120 and the wavefront modulator 130 is preferably stored in the memory in advance. More specifically, relay optical system moving amounts necessary for arranging the pupil planes of all the objective lenses to be used and the wavefront modulator 130 in a conjugate relationship are preferably stored in the memory in advance.

The optically effective diameter of the wavefront modulator 130 is preferably made in advance to match the diameter of a light beam from an objective lens that provides the maximum diameter for the light beam. This facilitates adjustment of the relay optical system 120 because the movement of the lenses is only for expanding the diameter of the light beam.

The microscope of this embodiment allows the user to observe at any position shifted from a focal plane without moving an observation target or objective lens along the optical axis. In addition, the microscope can suit for objective lenses having different magnifications with only one wavefront modulator. Therefore, an observation position can be scanned along the optical axis by properly controlling the wavefront modulator.

### Second Embodiment

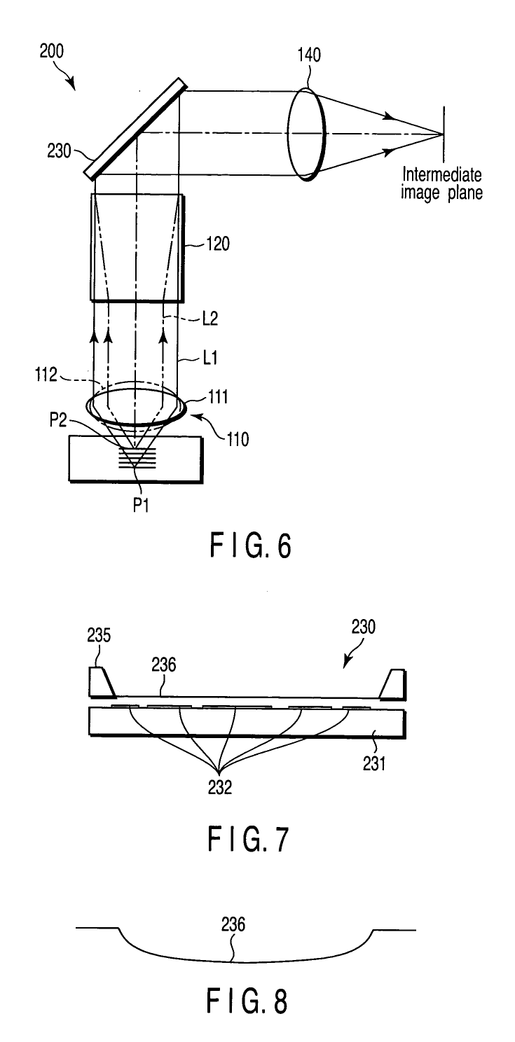

This embodiment is directed to a microscope having a reflection wavefront modulator. FIG. 6 schematically shows the arrangement of the microscope according to the second embodiment. The same reference numerals as in FIG. 1 denote the same members in FIG. 6, and a detailed description thereof will be omitted.

As shown in FIG. 6, a microscope 200 of this embodiment comprises a reflection wavefront modulator 230 on an optical path between an objective lens 110 and an imaging lens 140 in place of the transmission wavefront modulator 130 according to the first embodiment.

The reflection wavefront modulator 230 comprises, for example, a deformable mirror. Deformable mirrors include an electrostatic actuation type, piezoelectric actuation type, and the like, several types of which are shown in, for example, FIGS. 5A to 5C in U.S. Pat. No. 6,771,417 B1. The wavefront modulator 230 may comprise an electrostatic actuation type deformable mirror.

FIG. 7 schematically shows the arrangement of an electrostatic actuation type deformable mirror applicable to the wavefront modulator in FIG. 6. The deformable mirror 230 comprises a lower substrate 231 and upper substrate 235. The lower substrate 231 is formed from, for example, a silicon substrate, and has split electrodes 232 on its upper surface. The split electrodes 232 comprise, for example, ring-like electrodes like those shown in FIG. 3. The upper substrate 235 has a frame-like shape and supports a thin-film mirror 236. The thin-film mirror 236 is deformable and has a uniform electrode on its lower surface.

When a voltage is applied between the electrode of the thin-film mirror 236 and the split electrodes 232, electrostatic force is generated between them to deform the thin-film mirror. Applying a proper voltage to each split electrode 232 makes it possible to deform the thin-film mirror 236 so as to have a large slope at the outer periphery. Therefore, the wavefront of a light beam can be modulated, i.e., corrected, so that a change in the wavefront correction amount with a change in distance r from the center becomes large at the outer periphery of the light beam.

Referring to FIG. 6, both a light beam L1 and a light beam L2 fall on the deformable mirror 230 with the same diameter. It is therefore possible to modulate the wavefront of each of the light beams L1 and L2 so that a change in the wavefront correction amount with a change in the distance r from the center becomes large at the outer periphery of each light beam, i.e., to correct the wavefront of each of the light beams L1 and L2.

This embodiment has the same merits as those of the first embodiment. In addition, in a wavefront modulator constituted by the above liquid crystal cell, chromatic aberration may occur because the cell exhibits different refractive indices with respect to different wavelengths. In contrast to this, the deformable mirror causes no chromatic aberration. This embodiment can therefore suppress the occurrence of chromatic aberration. In addition, the deformable mirror is higher in wavefront modulation speed than the liquid crystal cell. Therefore, this embodiment can perform wavefront modulation at a higher speed than the first embodiment.

### Third Embodiment

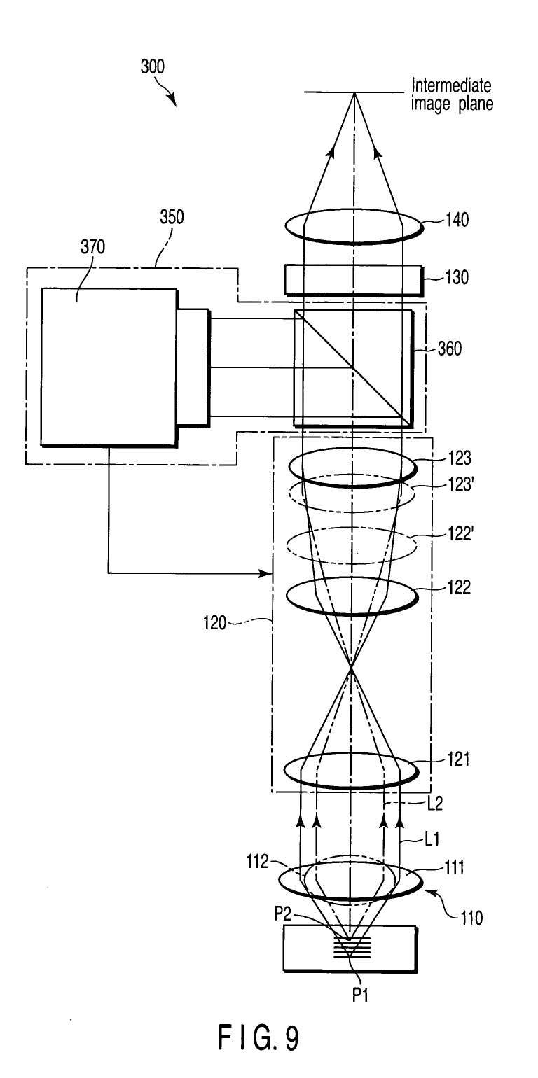

This embodiment is directed to a microscope having a light beam diameter measuring unit. FIG. 9 schematically shows the arrangement of the microscope according to the third embodiment of the present invention. More specifically, FIG. 9 shows the arrangement obtained by adding the light beam diameter measuring unit to the arrangement shown in FIG. 4. The same reference numerals as in FIG. 4 denote the same members in FIG. 9, and a detailed description thereof will be omitted.

As shown in FIG. 9, a microscope 300 of this embodiment is equivalent to the arrangement shown in FIG. 4 to which a light beam diameter measuring unit 350 is added. The light beam diameter measuring unit 350 comprises a beam splitter 360 and CCD camera unit 370. The beam splitter 360 is located on an optical path between a relay optical system 120 and a wavefront modulator 130. The CCD camera unit 370 is located on one of optical paths split by the beam splitter 360.

In the microscope 300 of this embodiment, a light beam traveling from the relay optical system 120 to the wavefront modulator 130 is partly branched by the beam splitter 360, and the branched light beam enters the CCD camera unit 370. The CCD camera unit 370 measures the diameter of the incident light beam. Movable lenses 122 and 123 of the relay optical system 120 are moved so that the diameter of the light beam that is measured by the CCD camera unit 370 becomes substantially equal to the optically effective diameter of the wavefront modulator 130.

A change in the magnification of the relay optical system 120 is obtained from the moving amounts of the movable lenses 122 and 123. The optical distance between the relay optical system 120 and the wavefront modulator 130 is then adjusted on the basis of the obtained change in magnification so that the pupil plane of the objective lens 110 and the wavefront modulator 130 are arranged in a conjugate relationship.

This embodiment has the same merits as those of the first embodiment. In addition, the embodiment can move the movable lenses 122 and 123 of the relay optical system 120 without measuring a light beam for each objective lens in advance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A microscope comprising:
an objective lens;
an imaging lens, which constitutes an imaging optical system in cooperation with the objective lens;
a wavefront modulator, which is located on an optical path between the objective lens and the imaging lens; and
a light beam diameter controlling unit, which is located on the optical path between the wavefront modulator and the objective lens and changes a diameter of a light beam from the objective lens to a substantially constant diameter.

2. A microscope according to claim 1, wherein the light beam diameter controlling unit changes the diameter of the light beam from the objective lens to a diameter substantially equal to an optically effective diameter of the wavefront modulator.

3. A microscope according to claim 1, wherein the light beam diameter controlling unit comprises a relay optical system including a movable lens movable along an optical axis of the imaging optical system.

4. A microscope according to claim 3, wherein an optical distance between the relay optical system and the wavefront modulator is adjustable.

5. A microscope according to claim 4, further comprising a memory that stores necessary information associated with a change in light beam diameter in advance.

6. A microscope according to claim 5, wherein the memory stores necessary movable lens moving amounts associated with all objective lenses to be used.

7. A microscope according to claim 5, wherein the memory stores necessary information associated with adjustment of an optical distance between the relay optical system and the wavefront modulator.

8. A microscope according to claim 7, wherein the memory stores a relay optical system moving amount necessary for arranging a pupil plane of the objective lens and the wavefront modulator in a conjugate relationship.

9. A microscope according to claim 1, wherein the wavefront modulator comprises a deformable mirror.

10. A microscope according to claim 1, which further comprises a light beam diameter measuring unit, and in which the light beam diameter controlling unit changes the diameter of the light beam from the objective lens on the basis of a measurement result obtained by the light beam diameter measuring unit.
